(19) United States
(12) Patent Application Publication
(10) Pub. No.: US 2010/0131600 A1
(43) Pub. Date: May 27, 2010

(54) MESSAGE MASKING IN MIDDLEWARE ENVIRONMENTS

(75) Inventors: Avinashgupta K. Manikeyashetty, Bangalore (IN); Amrutha S. Shenoy, Konena Agrahara (IN); Lohitashwa Thyagaraj, Bangalore (IN); Jason Edmeades, Eastleigh Hampshire (GB)

Correspondence Address: FERENCE & ASSOCIATES LLC, 409 BROAD STREET, PITTSBURGH, PA, 15143, US

(73) Assignee: IBM Corporation, Armonk, NY (US)

(21) Appl. No.: 12/276,920

(22) Filed: Nov. 24, 2008

(51) Int. Cl. G06F 15/82

(52) U.S. Cl. 709/206

(57) ABSTRACT

In the context of middleware products, an arrangement wherein a sender tags messages with authorization information identifying those users or groups who are authorized to view or receive the messages. Thus, even if multiple users will be connected to the same queue for reading messages, only specific receivers/consumers will be able to get the messages. Not only is a comfortable degree of security ensured, but the need to waste system resources, e.g., by using multiple queues for different kinds of messages, is summarily avoided.

### BACKGROUND

Currently in WebSphere MQ (a family of network communication software products launched by IBM in 1992) and in other message-oriented middleware (MOM) products, a sender can send a message to a particular queue (in a point-to-point model), but the sender does not have the ability to authorize or control who can get or view the messages. Generally, MOM is a client/server infrastructure embodied by software that resides in both portions of client/server architecture and typically supports asynchronous calls between the client and server applications. However, similar arrangements can be made in a point-to-point (client-to-client) environment as well. In any environment employed, message queues provide temporary storage when the destination program is busy or not connected.

Currently, if there are two are more receivers (or “consumers”) polling on the same queue for messages, as long as the consumers have authority to access the queue itself then any of them can retrieve any message from the queue. This clearly creates problems from a security point of view, and solutions have indeed been attempted.

In one solution, the sender can set message properties on the message and send the message to the queue, while the consumer/receiver can then specify message selectors to retrieve only specific messages from the queue. However, this merely results in client-side security, meaning any malicious application need not necessarily specify a message selector and can still pull messages from queue.

In another solution, different queues can be used for different kinds of messages, or “virtual queues” can be used which point to the local queue and to users configured for those virtual queues. While this does more to address security issues, it leads to a great increase in administrative and “housekeeping” tasks, such as the need to maintain multiple queues, while an undesirable byproduct is that multiple I/O resources are consumed.

### SUMMARY

Broadly contemplated herein, in accordance with at least one embodiment of the invention, is an arrangement wherein a sender tags messages with authorization information identifying those users or groups who are authorized to view or receive the messages. Thus, even if multiple users will be connected to the same queue for reading messages, only specific receivers/consumers will be able to get the messages. Not only is a comfortable degree of security ensured, but the need to waste system resources, e.g., by using multiple queues for different kinds of messages, is summarily avoided.

In summary, this disclosure describes a method comprising providing a physical computing device, providing message-oriented middleware at the physical computing device, appending a masking property to a message, sending the message to the message-oriented middleware, accepting information relating to a receiver, validating the accepted receiver information, and availing the message to the receiver upon successful validation of the receiver information.

This disclosure also described an apparatus comprising a physical computing device, the physical computing device comprising a main memory, message-oriented middleware provided at the physical computing device and being in communication with the main memory, an appender which acts to append a masking property to a message, a sender which acts to send a message to the message-oriented middleware, an accepter which accepts information relating to a receiver, a validator which validates accepted receiver information, and an availer which avails a message to a receiver upon successful validation of receiver information.

Furthermore, this disclosure additionally describes a program storage device readable by machine, tangibly embodying a program of instructions executable by the machine to perform a method comprising: providing a physical computing device, providing message-oriented middleware at the physical computing device, appending a masking property to a message, sending the message to the message-oriented middleware, accepting information relating to a receiver, validating the accepted receiver information, and availing the message to the receiver upon successful validation of the receiver information.

### BRIEF DESCRIPTION OF THE DRAWINGS

FIG. 1 schematically illustrates a computer system with which a preferred embodiment of the present invention can be used.

FIG. 2 schematically illustrates a client and server arrangement.

FIG. 3 schematically illustrates a process of masking and sending a message.

### DETAILED DESCRIPTION

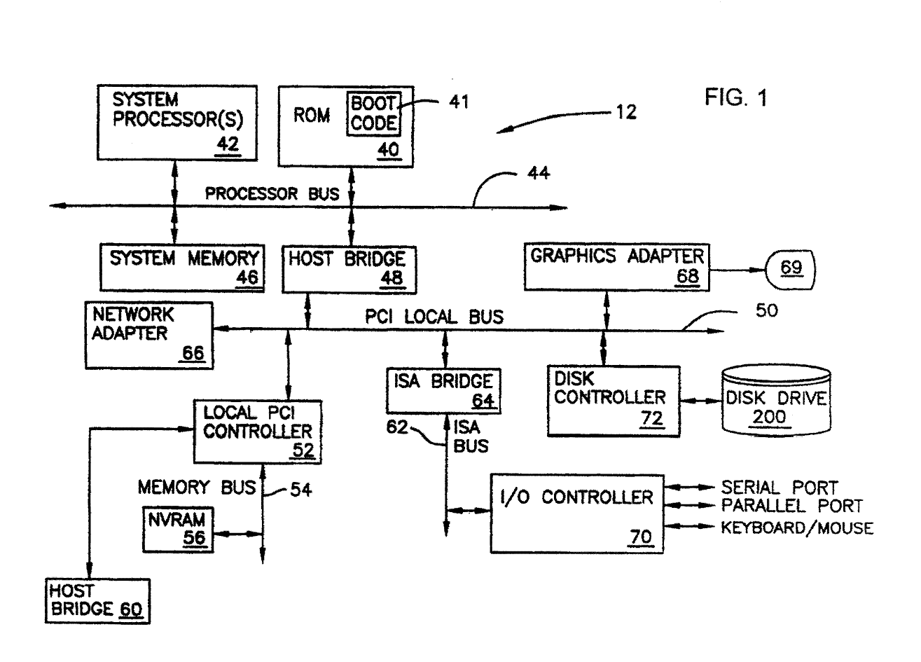

It will be readily understood that the embodiments of the invention, as generally described and illustrated in the Figures herein, may be arranged and designed in a wide variety of different configurations. Thus, the following more detailed description of the embodiments of the apparatus, system, and method of the embodiments of the invention, as represented in FIGS. 1-3, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that embodiment of the invention can be practiced without one or more of the specific details, or with other methods, components, materials, etc. In other instances, well-known structures, materials, or operations are not shown or described in detail to avoid obscuring aspects of embodiments of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes.

Referring now to FIG. 1, there is depicted a block diagram of an embodiment of a computer system 12. The embodiment depicted in FIG. 1 may be a notebook computer system, such as one of the ThinkPad® series of personal computers previously sold by the International Business Machines Corporation of Armonk, N.Y., and now sold by Lenovo (US) Inc. of Morrisville, N.C.; however, as will become apparent from the following description, the embodiments of the invention may be applicable to any data processing system. Notebook computers, as may be generally referred to or understood herein, may also alternatively be referred to as “notebooks”, “laptops”, “laptop computers” or “mobile computers”.

As shown in FIG. 1, computer system 12 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to a local area network (LAN), and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard and mouse. In addition, I/O controller 70 supports external communication by computer system 12 via serial and parallel ports, including communication over a wide area network (WAN) such as the Internet. A disk controller 72 is in communication with a disk drive 200 for accessing external memory. Of course, it should be appreciated that the system 12 may be built with different chip sets and a different bus structure, as well as with any other suitable substitute components, while providing comparable or analogous functions to those discussed above.

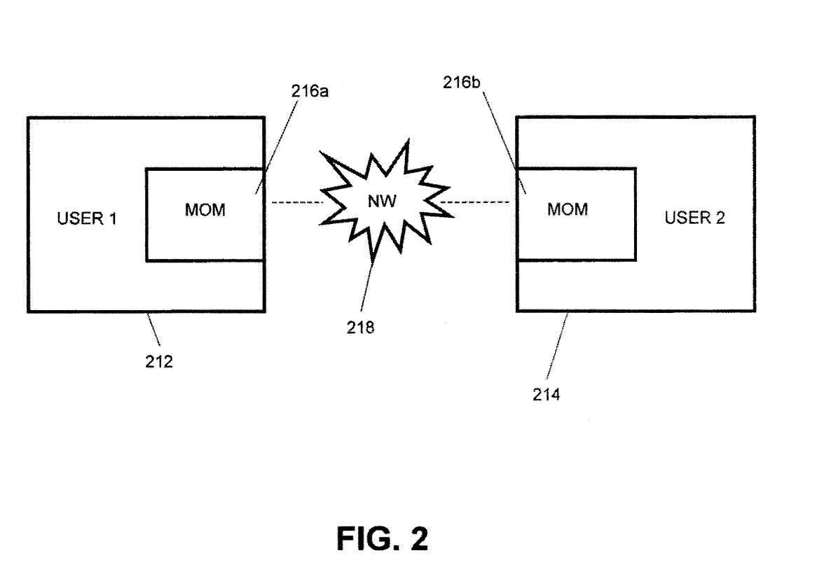

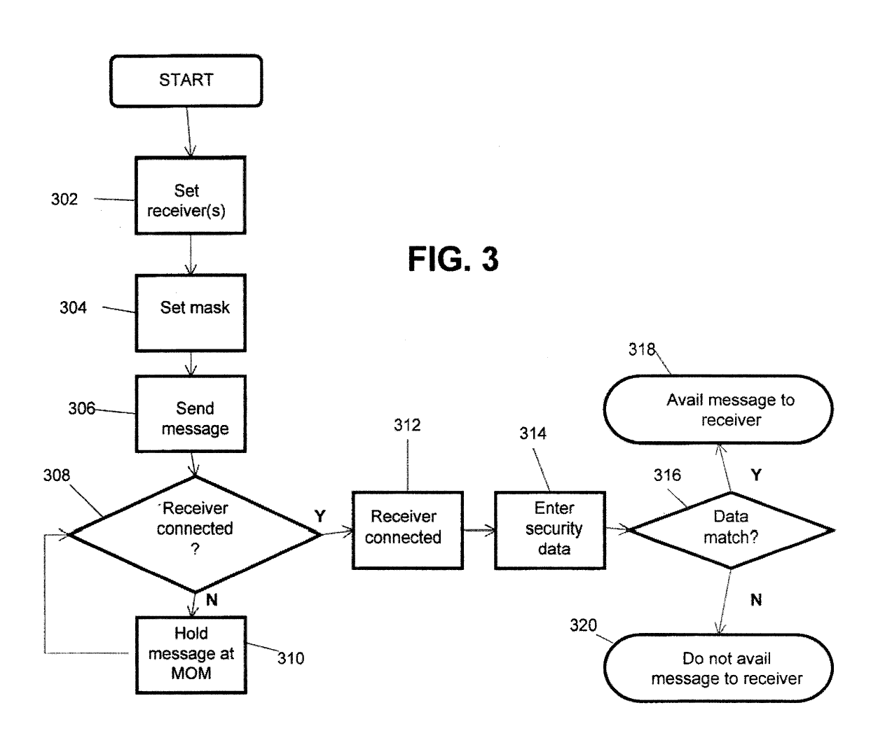

Reference may now be made herethroughout to FIGS. 2 and 3. It should be understood that the arrangements and processes broadly contemplated in accordance with FIGS. 2 and 3 can be applied to a very wide range of computer systems, including that indicated at 12 in FIG. 1.

As mentioned above, there is broadly contemplated herein, in accordance with at least one embodiment of the invention, an arrangement wherein a sender tags messages with authorization information identifying those users or groups who are authorized to view or receive the messages.

For example, in a banking environment, there can be one common queue called “Account”, where both “SavingsAccount” and “CurrentAccount” users can connect to the same queue. If it is assumed that messages for both Savings and Current account can be sent to the same queue then, in accordance with embodiments of the invention, even though SavingsAccount users and CurrentAccount users are connected to the same queue, each group user will be able to view or receive only their group specific messages, thereby reducing the overhead of maintaining multiple queues and multiple I/O resources. Accordingly, there is broadly contemplated, in accordance with embodiments of the invention, an arrangement for securing or masking a message sent by the sender so that only a specified user can view the messages.

Referring to FIG. 2, there are shown a first user 212 and second user 214. Either or both of the first and second users 212/214 may involve the use of essentially any computer system, including one configured similarly to that indicated at 12 in FIG. 1. As is known conventionally, message-oriented middleware (MOM) may be installed in both locations 212/214 (as indicated at 216a and 216b, respectively), while locations 212/214, along with their respective components of the MOM 214a/b, are typically communicable with one another over essentially any suitable network 218. Of course, the locations 212/214 may include a suitable interface via which a user may input a message for transmission to the MOM. Also, it should be understood that FIG. 2 could relate to a client/server relationship instead of a point-to-point relationship (e.g., “User1” 212 could be a client while “User2” 214 could be a server). Accordingly, it should be appreciated that the embodiments of the invention are applicable to a very wide variety of environments involving one or more senders and one or more receivers, and that the discussion herebelow and herethroughout should not be construed as necessarily being limited to any one such environment.

The disclosure now turns to an example of a solution in accordance with at least one embodiment of the invention. The solution may be implemented essentially on any suitable MOM arrangement, such as WebSphere MQ as the messaging provider. Reference may be made to the process flowchart in FIG. 3.

When a sender intends to send a message authorized to a particular user or group (either or which may be regarded as “receiver”), the sender may set a property on the message specifying one or more UserID's corresponding to the intended receiver(s) (302) along with a “masking” property (304) indicating that the message is to be masked. For instance, the masking property can be embodied by “MaskMessage=true”. Accordingly, by way of an illustrative and non-restrictive example, the message may have the following parameters attached to it:

MQMD.DestinedUsers=SavingAccountUser,SavingsAccountGroup

MQMD.MaskMessage=true

The message can then be sent to the MOM (e.g., WebSphere MQ) (306). Once the message is sent, and as long as a potential receiver has not yet connected, no immediate check need be made by the MOM, and nothing more need be done with the message (308, 310). However, when a user at the receiving end does connect to the MOM (308,312) to receive and/or read messages, that user (the receiver) may provide security information implicitly in the form of user-id and/or password. Before the receiver is able to read a message, UserID/Password and/or group memberships can be validated against the “DestinedUsers” property of the message (316). This validation will be primarily done by the server side part of MOM (308,312). If such data match, then the receiver will be able to view and/or receive the message (318).

On the other hand, should there be another user connected to the same queue and that user's UserID does not match the message parameters, then the message will not be visible to that user (320).

Generally, the sender (or sender application) need only specify the UserID or GroupID corresponding to any intended recipient(s), thereby providing the sender with complete control as to who can view or receive the message.

It is to be understood that the invention, in accordance with at least one embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

Generally, embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Generally, although illustrative embodiments of the present invention have been described herein with reference to the accompanying drawings, it is to be understood that the invention is not limited to those precise embodiments.

What is claimed is:

1. A method comprising:
providing a physical computing device;
providing message-oriented middleware at the physical computing device;
appending a masking property to a message;
sending the message to the message-oriented middleware;
accepting information relating to a receiver;
validating the accepted receiver information; and
availing the message to the receiver upon successful validation of the receiver information.

2. The method according to claim 1, further comprising:
appending intended receiver information to the message;
said validating comprising comparing the accepted receiver information to the intended receiver information.

3. The method according to claim 2, wherein said appending comprises appending a list of destined users to the message.

4. The method according to claim 2, wherein said appending comprises appending a user ID relating to the receiver.

5. The method according to claim 2, wherein said accepting comprises accepting a user ID relating to the receiver.

6. The method according to claim 2, wherein said accepting comprises accepting group ID information relating to the receiver.

7. The method according to claim 1, wherein said sending comprises enqueuing the message at the message-oriented middleware.

8. The method according to claim 1, further comprising holding the message at the message-oriented middleware until a receiver attempts to access the message.

9. An apparatus comprising:
a physical computing device;
said physical computing device comprising a main memory;
message-oriented middleware provided at said physical computing device and being in communication with said main memory;
an appender which acts to append a masking property to a message;
a sender which acts to send a message to said message-oriented middleware;
an accepter which accepts information relating to a receiver;
a validator which validates accepted receiver information; and
an availer which avails a message to a receiver upon successful validation of receiver information.

10. The apparatus according to claim 9, wherein:
said appender further acts to append intended receiver information to a message;
said validator acts to compare accepted receiver information to intended receiver information.

11. The apparatus according to claim 10, wherein said appender acts to append a list of destined users to the message.

12. The apparatus according to claim 10, wherein said appender acts to append a user ID relating to the receiver.

13. The apparatus according to claim 10, wherein said accepter acts to accept a user ID relating to the receiver.

14. The apparatus according to claim 10, wherein said accepter acts to accept group ID information relating to the receiver.

15. The apparatus according to claim 9, wherein said message-oriented middleware acts to enqueue incoming messages.

16. The apparatus according to claim 9, wherein said message-oriented middleware acts to hold a message until a receiver attempts to access the message.

17. A program storage device readable by machine, tangibly embodying a program of instructions executable by the machine to perform a method comprising:
providing a physical computing device;
providing message-oriented middleware at the physical computing device;
appending a masking property to a message;
sending the message to the message-oriented middleware;
accepting information relating to a receiver;
validating the accepted receiver information; and
availing the message to the receiver upon successful validation of the receiver information.

18. The program storage device according to claim 17, further comprising:
appending intended receiver information to the message;
said validating comprising comparing the accepted receiver information to the intended receiver information.

19. The program storage device according to claim 17, wherein said sending comprises enqueuing the message at the message-oriented middleware.

20. The program storage device according to claim 17, further comprising holding the message at the message-oriented middleware until a receiver attempts to access the message.
